(19) United States
(12) Patent Application Publication
(10) Pub. No.: US 2013/0100107 A1
(43) Pub. Date: Apr. 25, 2013

(54) METHOD AND APPARATUS FOR MODEL BASED ERROR DIFFUSION TO REDUCE IMAGE ARTIFACTS ON AN ELECTRIC DISPLAY

(71) Applicants: Jeho Lee, Palo Alto, CA (US); Manu Parmar, Sunnyvale, CA (US); Nao S. Chuei, San Mateo, CA (US); Koorosh Aflatooni, Cupertino, CA (US)

(72) Inventors: Jeho Lee, Palo Alto, CA (US); Manu Parmar, Sunnyvale, CA (US); Nao S. Chuei, San Mateo, CA (US); Koorosh Aflatooni, Cupertino, CA (US)

(73) Assignee: QUALCOMM MEMS Technologies, Inc., San Diego, CA (US)

(21) Appl. No.: 13/407,568

(22) Filed: Feb. 28, 2012

Related U.S. Application Data
(60) Provisional application No. 61/550,136, filed on Oct. 21, 2011.

(51) Int. Cl. G09G 5/00

(52) U.S. Cl. 345/212; 345/204

(57) ABSTRACT

This disclosure provides methods and apparatus, including computer programs encoded on computer storage media, for reducing visual aberrations on an electronic display. One aspect is a method of writing an input image data value to a display element in a electronic display. The method includes receiving an input image data value, and quantizing the image data value based on a threshold. The threshold may be modulated based on a voltage drive signal provided to the display element in the electronic display. The method may also write the quantized image data value to the display element.

### CROSS-REFERENCE TO RELATED APPLICATIONS

The disclosure claims priority to U.S. Provisional Patent Application No. 61/550,136 filed Oct. 21, 2011, entitled “METHODS AND APPARATUS FOR MODEL BASED ERROR DIFFUSION TO REDUCE IMAGE ARTIFACTS ON AN ELECTRONIC DISPLAY,” and assigned to the assignee hereof. The disclosure of this prior application is considered part of, and is incorporated by reference in, this disclosure.

### TECHNICAL FIELD

This disclosure relates to methods and apparatus for error diffusion of images displayed on electronic displays, for example, displays that include interferometric modulators.

### DESCRIPTION OF THE RELATED TECHNOLOGY

Electromechanical systems (EMS) include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

One characteristic of interferometric modulators is they may accumulate charge on their conductive surfaces when a constant voltage is asserted for a period of time. This charge build up may have effects on the performance of these devices. For example, a display element with charge build up may not actuate in the same manner as a display element without charge build up. For a given voltage, charge buildup may affect the relative positioning of conductive plates of an interferometric modulator device such that it may not have the same air gap as an interferometric modulator without charge build up.

Because the reflectance of the interferometric modulator device is determined partially based on the size of the air gap, charge build up may affect the visual appearance of the device. The charge build up may also change the release and actuation voltages of the interferometric device, which may alter the tunable window of voltages for the devices. Changes in display device tuning windows across a display panel may affect the ability of the drive scheme to accurately and consistently rip images. Charge build up may also contribute to display device stiction and reduce the lifetime of the display device.

To prevent this charge build up, the polarity of the potential between segment lines and common lines of a display device may be changed periodically. This change in potential may manifest visual effects in an image displayed.

### SUMMARY

The systems, methods and devices of the disclosure each have several innovative aspects, no single one of which is solely responsible for the desirable attributes disclosed herein.

One innovative aspect is a method to display an image in an electronic display. The method may include receiving an input image data value of the image, and quantizing the input image data value based on a threshold. The threshold may be modulated based, at least in part, on a voltage of a display element drive signal applied onto a display element of the electronic display. The method may also include writing the quantized image data value to the display element. In some implementations, the electronic display of the method includes a plurality of common lines and a plurality of segment lines connected to an array of display elements. In these implementations, the voltage of the display element drive signal is the voltage between a common line and a segment line that are configured to drive the display element, and at least two display element drive signals with different voltages drive different display elements in the display to render the same data value. In some other implementations the method includes error diffusing a quantization error resulting from quantizing the image data value based on the threshold.

In some implementations, the threshold is below a median threshold value if the voltage drive signal darkens the display element relative to a median hold voltage. In some implementations, the threshold is above a median threshold value if the modulated voltage drive signal lightens the display element relative to a median hold voltage.

In some implementations, the method includes iteratively repeating the receiving, quantizing, and writing for a plurality of display elements within the electronic display.

Another innovative aspect disclosed is an apparatus for driving a display. The apparatus includes a segment driver configured to drive a plurality of segment lines of the display, a common driver configured to drive a plurality of common lines of the display, the plurality of the segment lines and the plurality of common lines connected to an array of display elements in the display. In these implementations, the common driver is configured to alternate voltage states applied to the plurality of common lines in a first pattern having a first frequency spectrum, and the segment driver is configured to alternate voltage states applied to the plurality of segment lines in a second pattern having a second frequency spectrum. The apparatus also includes a halftoning module, configured to modulate a quantization threshold for the array of display elements based at least in part on the first frequency spectrum and the second frequency spectrum. In some implementations of the apparatus, the halftoning module is further configured to diffuse a quantization error resulting from quantizing an image data value based on the quantization threshold.

Another innovative aspect includes an apparatus to display an image. The apparatus includes an electronic display that includes an array of display elements, a plurality of common lines, and a plurality of segment lines, the plurality of common lines and the plurality of segment lines connected to the array of display elements. The apparatus also includes a segment driver configured to drive the plurality of segment lines and a common driver configured to drive the plurality of common lines. The segment driver and the common driver operate together to write data to the array of display elements. The apparatus also includes a halftoning module, configured to receive an input data value of the image, and quantize the image data value based on a threshold. The threshold is based on a voltage applied onto a display element of the array of display elements in the electronic display. The halftoning module is also configured to write the quantized image data value to the display element. In some implementations, the voltage difference is based on the voltage between a common line and a segment line that are configured to drive the display element.

In some other implementations, the apparatus also includes a processor that is configured to communicate with the electronic display, the processor being configured to process image data, and a memory device that is configured to communicate with the processor. In some implementations, the apparatus also includes a driver circuit configured to send at least one signal to the electronic display. In some other implementations, the apparatus includes a controller configured to send at least a portion of the image data to the driver circuit. In some of these implementations, an image source module is configured to send the image data to the processor. In some of these implementations, the image source module includes at least one of a receiver, transceiver, and transmitter. Some implementations of the apparatus include an input device configured to receive input data and to communicate the input data to the processor.

Another innovative aspect includes an apparatus for driving an electronic display including a plurality of common lines and a plurality of segment lines connected to an array of display elements. The apparatus includes a means for driving the plurality of segment lines, and a means for driving the plurality of common lines. At least two display elements in the array that are driven to render the same data are provided a different driving voltage. The apparatus also includes means for halftoning, configured to receive an input image data value of an image, and quantize the image data value based on a threshold. The threshold is modulated based on the voltage applied onto a display element of the array of display elements. The means for halftoning also writes the quantized image data value to the display element.

In some implementations, the means for driving the plurality of segment lines includes a column driver configured to drive the plurality of segment lines. In some other implementations, the means for driving the plurality of common lines includes a row driver configured to drive the plurality of common lines. In some implementations, the means for halftoning includes a processor configured to communicate with an array driver, the array driver including a row driver circuit and a column driver circuit, and wherein the processor is further configured to execute one or more software modules.

Another innovative aspect includes a non-transitory, computer readable storage medium having instructions stored thereon that cause a processing circuit to perform a method. The method includes receiving an input image data value of an image, and quantizing the image data value based on a threshold. The threshold is modulated based on a voltage drive signal provided onto a display element in the electronic display. The method also includes writing the quantized image data value to the display element.

In some implementations, the voltage drive signal is a voltage between a common line and a segment line that are configured to drive the display element. In some implementations, the method further includes diffusing a quantization error resulting from quantizing the image data value based on the threshold. In some implementations, the threshold is below a median threshold value if the voltage drive signal darkens the display element relative to a median hold voltage. In some other implementations, the threshold is above a median threshold value if the voltage drive signal lightens the display element relative to a median hold voltage.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example implementation of common lines and segment lines configured to drive a display array.

FIG. 9B shows two display elements 950 and 960 having different voltage differences between the electrodes of V_{H}−V_{S} and V_{H}+V_{S}, respectively, during a hold state.

FIG. 10 shows three graphs that illustrate examples of the variation in measured reflectance for a display module displaying red display elements (a), green display elements (b), and blue display elements (c).

FIG. 11 shows three graphs that illustrate examples of display device luminance as a function of hold voltage for a display panel with red display devices (a), green display devices (b), and blue display devices (c).

FIG. 12A is an image illustrating the severity of color differences in a red channel.

FIG. 12B shows an image that does not include a checkerboard voltage polarity pattern but is half toned using Floyd Steinberg error diffusion.

FIG. 12C shows the same image as FIG. 12B but it also includes a checkerboard polarity pattern while the display is being held in a stable state.

FIG. 13A shows an example of a checkerboard pattern.

FIG. 13B shows the discrete Fourier transform (DFT) of the checkerboard pattern illustrated in FIG. 13A.

FIG. 14A shows an example image without a checkerboard pattern that was halftoned using Floyd Steinberg error diffusion.

FIG. 14B shows an image using simulated hold voltages configured in a checkerboard polarity pattern.

FIG. 14C shows a close-up view of an area of FIG. 14B.

FIG. 15A illustrates the discrete Fourier transform (DFT) of the image shown in FIG. 14A.

FIG. 15B illustrates the discrete Fourier transform (DFT) of the image shown in FIG. 14B.

FIG. 16 shows an example data flow diagram for diffusing quantization error of an input pixel with Floyd Steinberg error diffusion.

FIG. 17A is an example system block diagram illustrating a visual display device including a plurality of interferometric modulators.

FIG. 17B is a flowchart illustrating one example of a method for reducing image artifacts caused by polarity patterns in an electronic display.

FIG. 18A illustrates an example of an image generated using model based error diffusion with threshold modulation.

FIG. 18B illustrates an example of an image including a checkerboard polarity pattern and generated using a model based error diffusion method.

FIG. 18C shows a close-up view of an area of FIG. 18B.

FIGS. 19A and 19B illustrate examples of images displayed on an IMOD display device.

FIG. 19C illustrates an example of a polarity pattern of a portion of a display.

FIGS. 20A and 20B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Various implementations include methods and apparatus, including computer readable media that perform a display model based error diffusion on an image. In some implementations of model based error diffusion, a quantization threshold for a display element is modulated based on a voltage difference at the display element. A display used for displaying the image may include a set of common lines and a set of segment lines connected to an array of display elements. Each display element may include an interferometric modulator. In some implementations, each display element can be connected to one of the common lines and one of the segment lines. A voltage applied to a common line is referred to as a common line voltage. Likewise, a voltage applied to a segment line is referred to as a segment line voltage. The common line voltage and the segment line voltage may operate together to drive one or more display elements connected to the respective common line and segment line.

A voltage difference across a display element may be based on a difference between a common line voltage and a segment line voltage that both drive the display element. Some bi-stable display elements can be driven to, and held at, a particular data value by applying a voltage differential across their segment and common lines. The voltage potential across these lines may vary while the device continues to express a particular color, as long as the variation of the voltage remains within the hysteresis window of the display device.

These varying voltages may affect the mechanical and optical characteristics of the display element. For example, display elements driven to render the same data value may appear different because of a voltage variation between the display elements, even though the variation remains within the hysteresis window of the display elements. In other words, display elements that are driven to reflect a certain (same) color may appear to reflect a different color (for example, a slightly different but still perceptible different color) creating in inconsistency in the color displayed by such display elements, resulting in an overall different color displayed. When these display elements are included in an electronic display and used to display an image (perceived by a human eye), visual aberrations in an image displayed on the display may result. Such visual aberrations may be more apparent, in some implementations, when a single color is rendered on a contiguous portion of the display. For example, one such aberration is a visually perceptible “checkerboard” pattern in a displayed image.

Implementations to address such aberrations can include modulating a quantization threshold of a display element such that the resulting error diffusion halftone images have specific frequency characteristics. For instance, the threshold can be modulated to compensate for the checkerboard pattern. In some implementations, the quantization threshold for pixels in black positions may be increased while the quantization threshold for pixels in white positions may be decreased. In other implementations, the modulation of the threshold may be reversed with respect to the pixel positions. Such implementations (or methods) may cause the halftone image's high frequency components that are near the diagonal locations at [±π, ±π] to move to the closest diagonal frequency. This may reduce negative interactions between the voltage polarity patterns across the segment and common lines of display elements and the halftone pattern of an image. The method may reduce the shared frequency components (e.g., diagonal) between the half tone pattern and the voltage polarity pattern. By doing so, the visual appearance of images rendered may be improved.

Particular implementations of the subject matter described in this disclosure can be implemented to realize one or more of the following potential advantages. Visual artifacts associated with the interaction of an error diffusion threshold and voltage polarity pattern may be reduced or eliminated. For example, noisy artifacts may be reduced, including artifacts in mid-tone regions. Some implementations of the model based halftoning methods disclosed herein are particularly useful in reducing artifacts in images rendered by lower bit-depth devices, for example, devices using eight bits or less to determine a pixel value of an image. These devices may include low bit-depth printers or low bit depth display devices.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted in an interferometric modulator by changing the thickness of the gap between a reflective movable layer and a stationary partially transmissive and partially reflective absorber layer by changing the position of the movable layer.

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

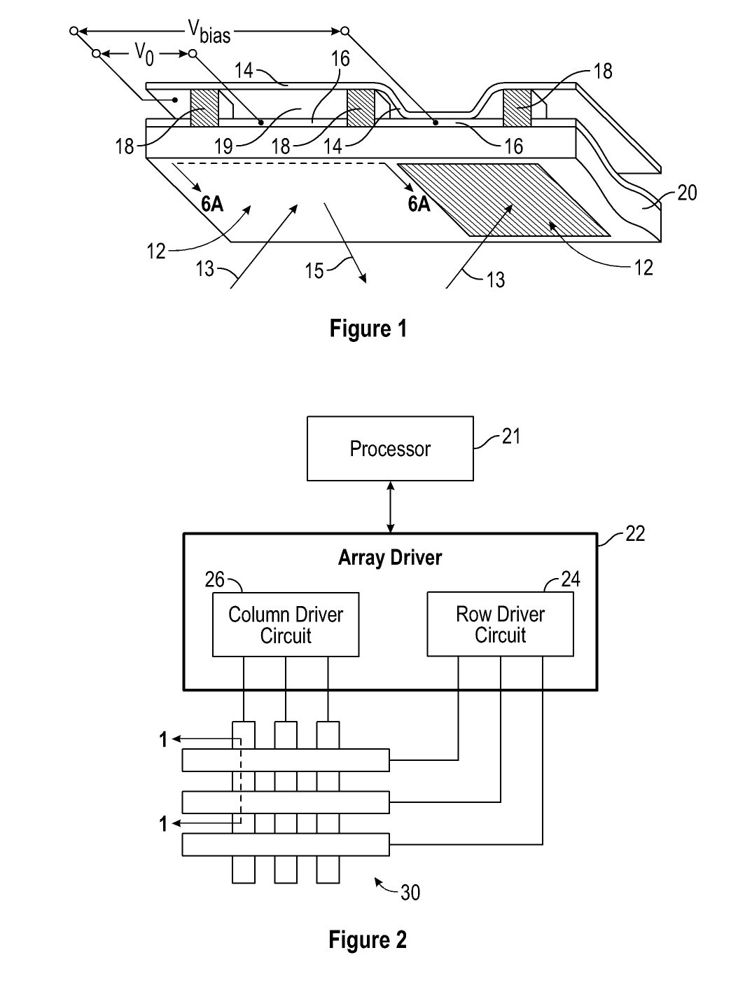

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

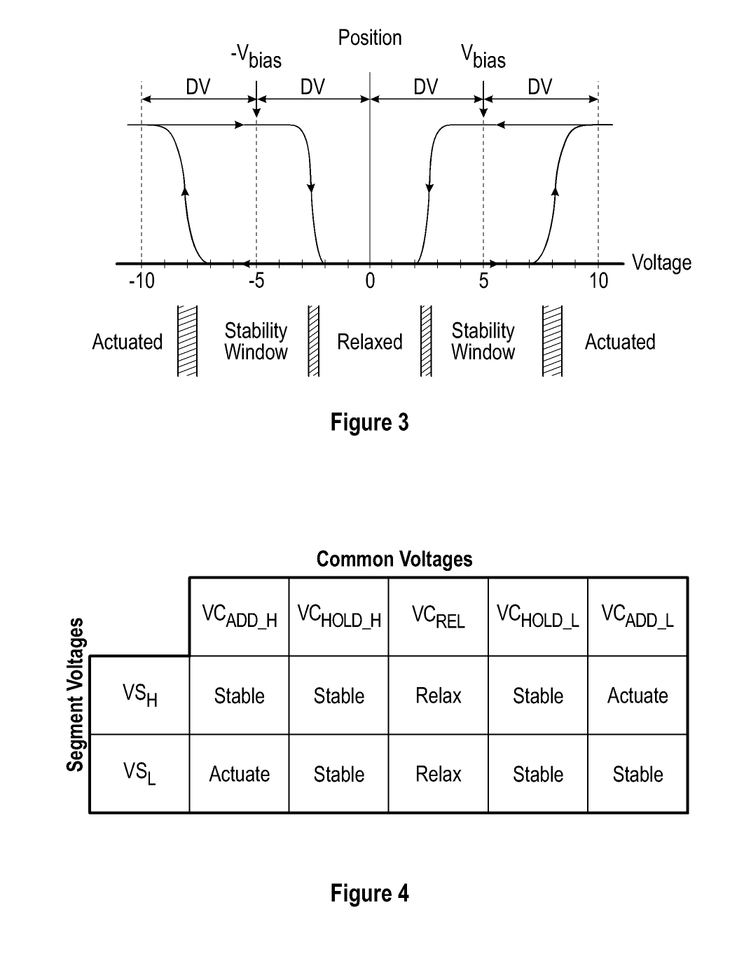

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or display device, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

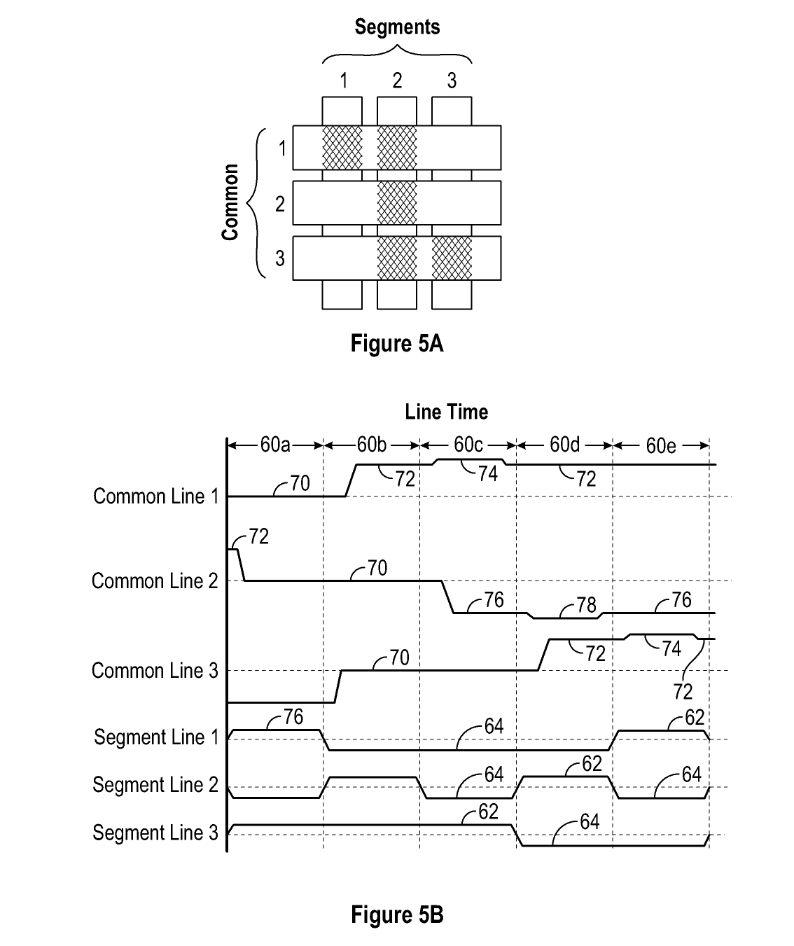

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{AD}_{_{—}}_{D L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

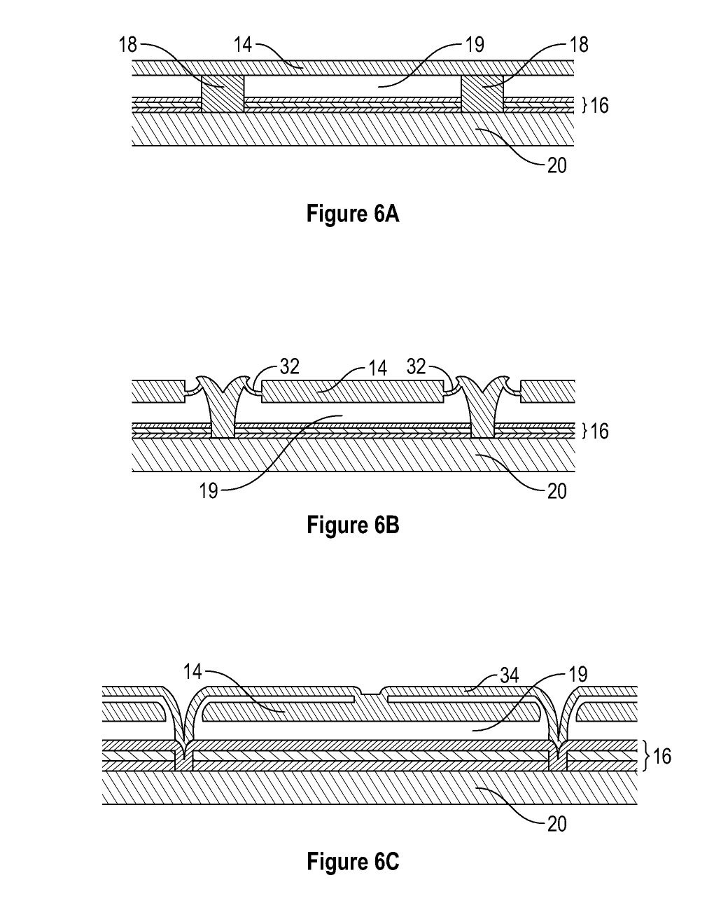

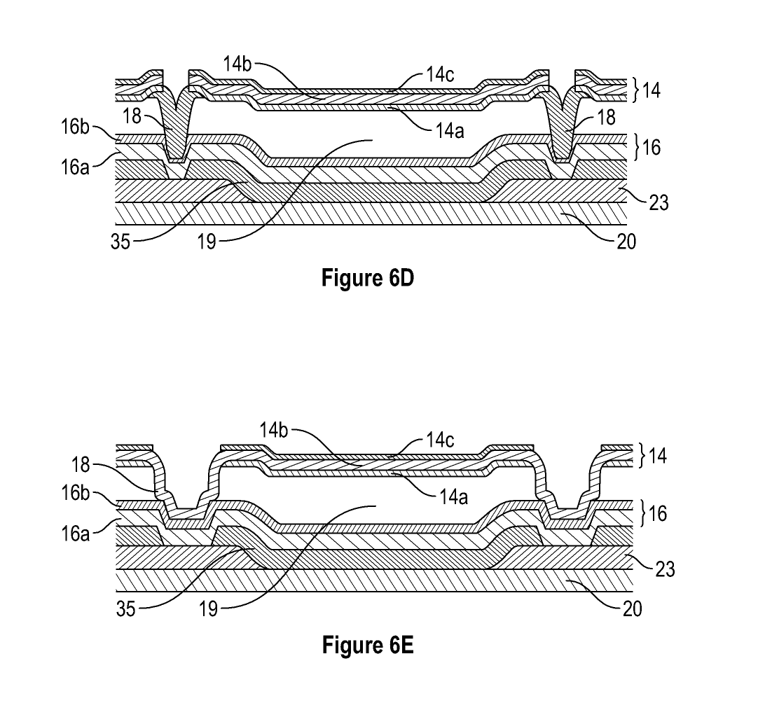

The details of the structure of interferometric modulators that operate in accordance with the principles set forth above may vary widely. For example, Figures 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

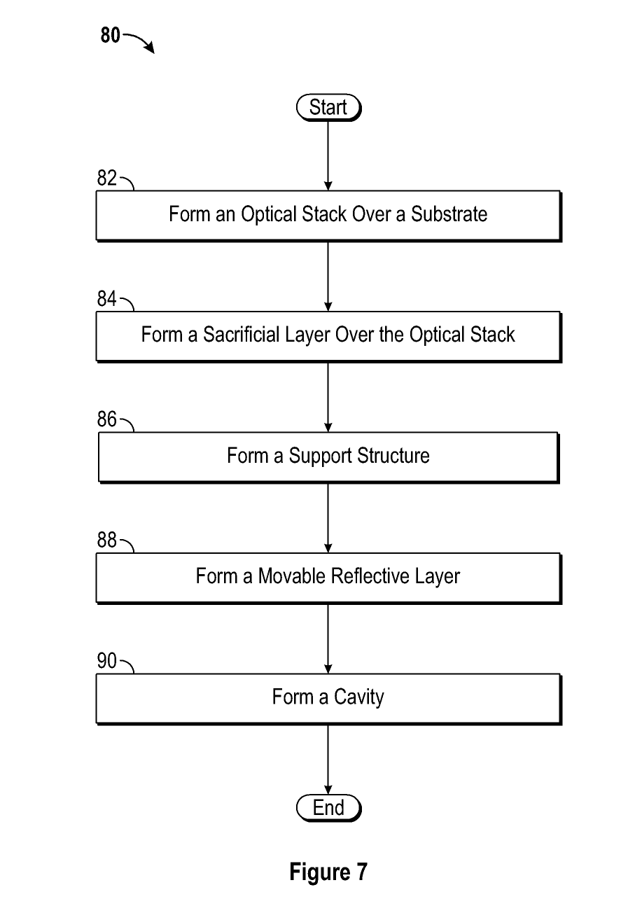

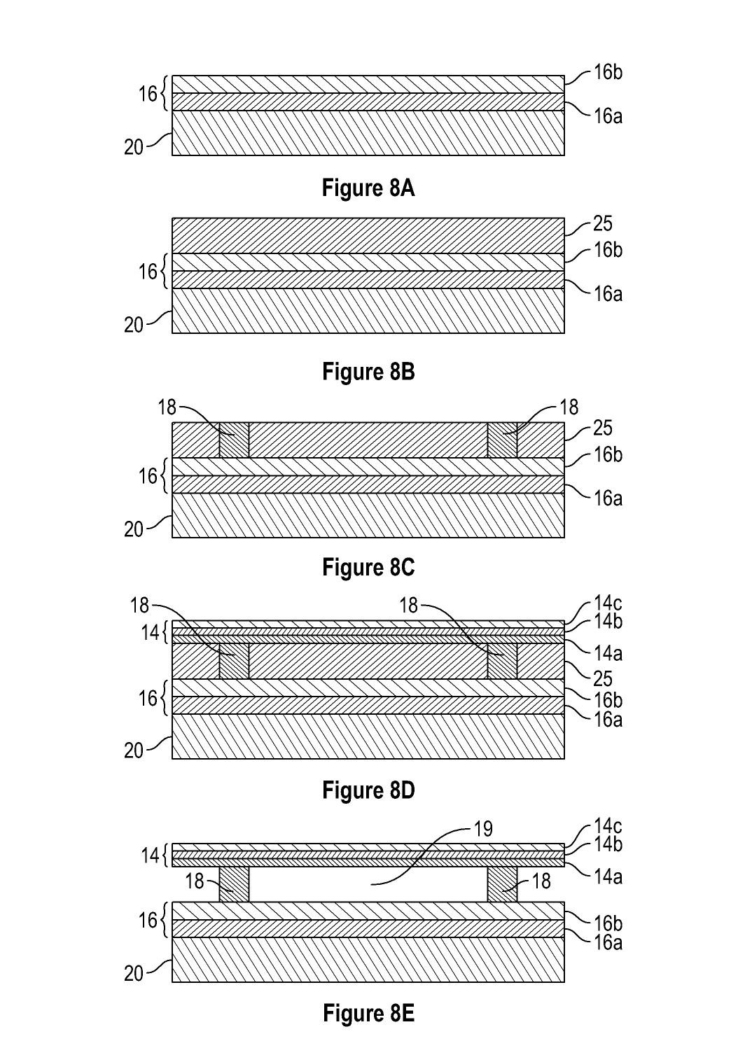

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a and 16b can be configured with both optically absorptive and conductive properties, such as the combined conductor/absorber sub-layer 16a. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b and 14c as shown in FIG. 8D. In some implementations, one or more of the sub-layers, such as sub-layers 14a and 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

The potential across the segment line and common line for a particular IMOD device can be represented as the difference between a common line voltage and a segment line voltage when the display device is in a stable or hold state. Effectively, the display device stays in a released, or actuated stable state (for example, see FIG. 4 voltage combinations indicating “Stable”), when the voltage difference on a display device's segment line and common line falls within a stability window for the device (for example, see FIG. 3). Because the common line provides for two hold voltage levels, V_{H} and −V_{H}, and the segment line also provides for two voltage levels, V_{S} and −V_{S}, four combinations of voltages are possible for this “stable” or “hold” state, listed below:

1. V_{H}−V_{S}

2. −(V_{H}−V_{S})

3. V_{H}+V_{S}

4. −(V_{H}+V_{S})

If in one implementation the stability window of a device is centered at 0 Volts, voltage combinations represented by voltage combinations (1) and (2) above result in equivalent potentials across the display device. Similarly, potentials resulting from voltages represented by voltage combinations (3) and (4) above also result in identical potentials across the display device.

By alternating the polarities of V_{H} and V_{S} for a display element, charge accumulation at the display element may be mitigated. The polarities may be alternated and balanced using several processes. For example, these processes can include frame-inversion and line-inversion. In a frame-inversion process, an entire array or panel of interferometric devices can be maintained at a fixed polarity, for example, V_{H}. The polarity of V_{H} can then be switched for each subsequent frame. In a line-inversion process, in addition to frame inversion, alternate lines of display elements within a frame are held at different polarities. In one implementation, V_{H} and V_{S} are alternated for each line of display elements, creating a checkerboard-like pattern of potentials.

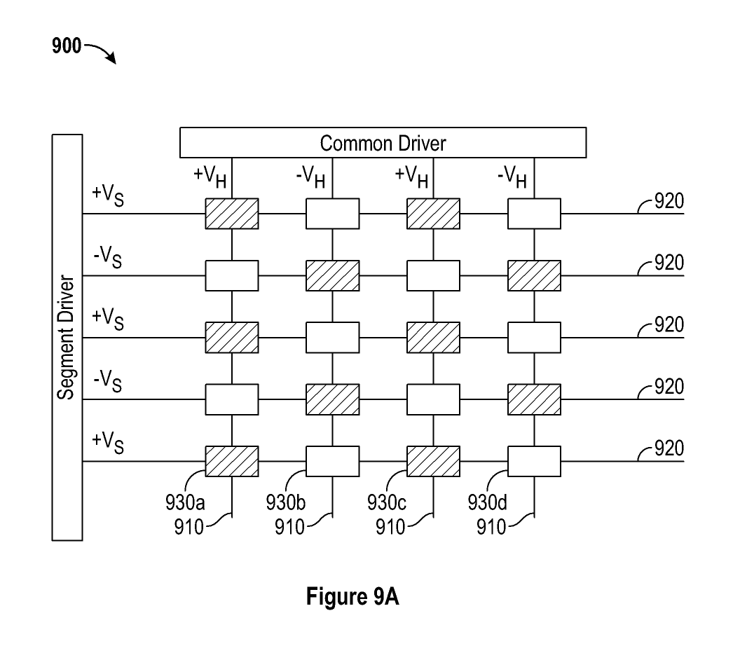

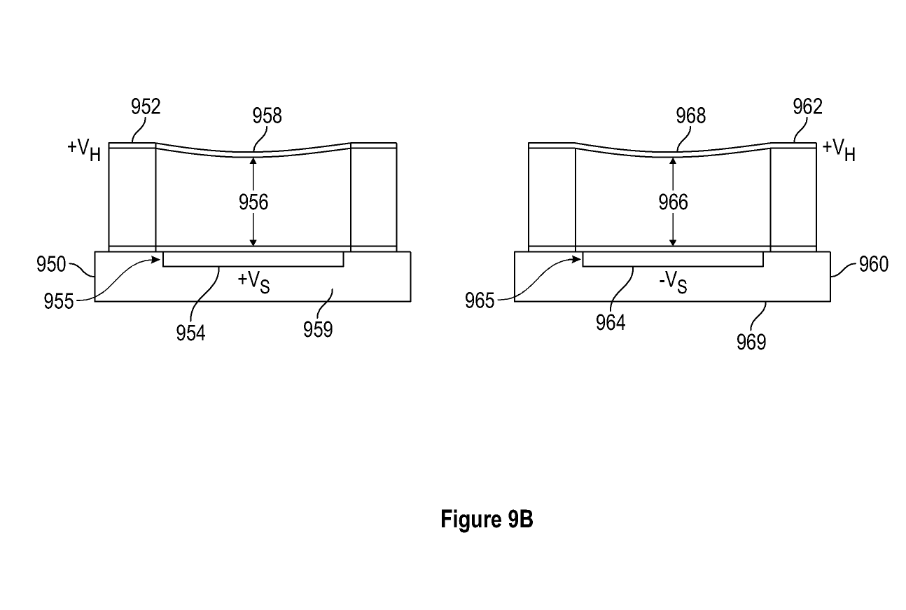

FIG. 9A shows an example implementation of common lines and segment lines configured to drive a display array 900. A Common Driver is connected to common lines 910. A Segment Driver is connected to segment lines 920. FIG. 9A also illustrates a display element 930 at each intersection of the common lines 910 and the segment lines 920. Manipulation of voltages on the common lines 910 and the segment lines 920 place the display devices 930 in a particular state (e.g., actuated or relaxed). The common lines 910 may be set to have alternating polarities (e.g., +V_{H}, −V_{H}, +V_{H}, −V_{H}). Similarly, the segment lines 920 may also be set to have alternating polarities (e.g., +V_{S}, −V_{S}, +V_{S}, −V_{S}, +V_{S}). This drive scheme results in a checkerboard polarity pattern as illustrated in FIG. 9A, where the black squares 930a correspond to display elements at the lower magnitude potential difference (e.g., V_{H}−V_{S} or −V_{H}+V_{S}) and light gray squares 930b correspond to display elements at the higher magnitude potential difference (e.g., V_{H}+V_{S} or −V_{H}−V_{S}). In other implementations, lower magnitude potential differences may result in lighter (or colored) appearing display elements while higher magnitude potential differences in a display element may result in a darker (or black) appearing display element. It should be understood that the relative difference in display element brightness illustrated in FIG. 9A is for illustration purposes only, and the relative brightness may vary by implementation.

With the voltage drive scheme illustrated in FIG. 9A, the variation of the display elements may be too great to be perceived accurately by the human visual system. For example, by varying the voltage of the common line driving signals for each column of display elements (e.g. in the X direction), the reflectance of display elements may alternate at the maximum possible frequency, i.e., alternating every column of display elements for at least a portion of the display. Similarly, the frequency at which the segment line driving signals (e.g., in the Y direction) alternate may also be at the maximum possible rate (alternating every line of display elements for at least a portion of the display).

Although the display devices can be configured such that potential differences of V_{H}−V_{S}, −(V_{H}−V_{S}), V_{H}+V_{S}, and −(V_{H}+V_{S}) maintain a display element in a current position, having different potential differences during the hold state may slightly change the position of the movable layer when it is relaxed, which impacts light reflected by the display element. For example, even when the applied voltages are within a stability window, a larger magnitude voltage can pull the movable layer, which is a flexible membrane, closer to a substrate, thus reducing the gap distance of the display element. The reduced gap distance can cause the display element to reflect or absorb different wavelengths of light.

FIG. 9B shows two display elements 950 and 960 having different voltage differences between the electrodes of V_{H}−V_{S} and V_{H}+V_{S}, respectively, during a hold state. Display element 950 includes a “top” movable electrode 952 having a movable membrane 958, and further includes an optical stack 955, including a stationary “bottom” electrode 954, disposed on a substrate 959. The optical stack 955 can include one or more other layers (not shown in FIG. 9B) including an absorber layer (e.g., a layer of chromium (Cr)). The terms “top,” “bottom,” and “on” in appropriate context are used here in reference to the orientation of FIG. 9B. In addition, the word “on” is a broad term herein and does not necessarily mean “in contact with” such that there can be other layers between a structure that is described as being “on” another structure, unless otherwise indicated. In addition, as used herein, in appropriate context the term “on” may indicate that one structure is fabricated on another structure, or that one structure is placed or provided on another structure. A voltage of +Vₕ is being asserted on the top electrode 952, while a voltage of +V_{S} is being asserted on the bottom electrode 954. This results in a potential difference of V_{H}−V_{S} across the display element 950. This potential difference causes movement of the movable membrane 958 to produce a gap distance 956 between the movable membrane 958 and the optical stack 955.

Display element 960 includes top movable electrode 962 having movable membrane 968 and further includes an optical stack 965, including a stationary “bottom” electrode 964, disposed on a substrate 969. The optical stack 955 can include one or more other layers (not shown in FIG. 9B) including an absorber layer (e.g., a layer of chromium (Cr)). In FIG. 9B, a voltage of +Vₕ is being asserted on the top electrode 962, while a voltage of −Vs is being asserted on the bottom electrode 964. This results in a potential difference of V_{H}+V_{S} across display element 960. This potential difference causes movement of the movable membrane 968 to produce a gap distance 966 between the movable membrane 968 and the optical stack 965.

As illustrated in FIG. 9B, at a voltage difference ΔV equal to V_{H}+V_{S}, the gap distance 966 of the display element 960 is less than the gap distance 956 of the left display element 950. As a result of these differences, display elements 950 and 960 may exhibit some amount of variation in appearance. This variation may be caused by differences in the optical absorption and/or interference that occurs in each display device because the optical absorption and/or interference of each display element 950 and 960 may depend at least in part, on the respective gap distances 956 and 966 between the reflective movable membranes 958 and 968 and the respective optical stacks 955 and 965.

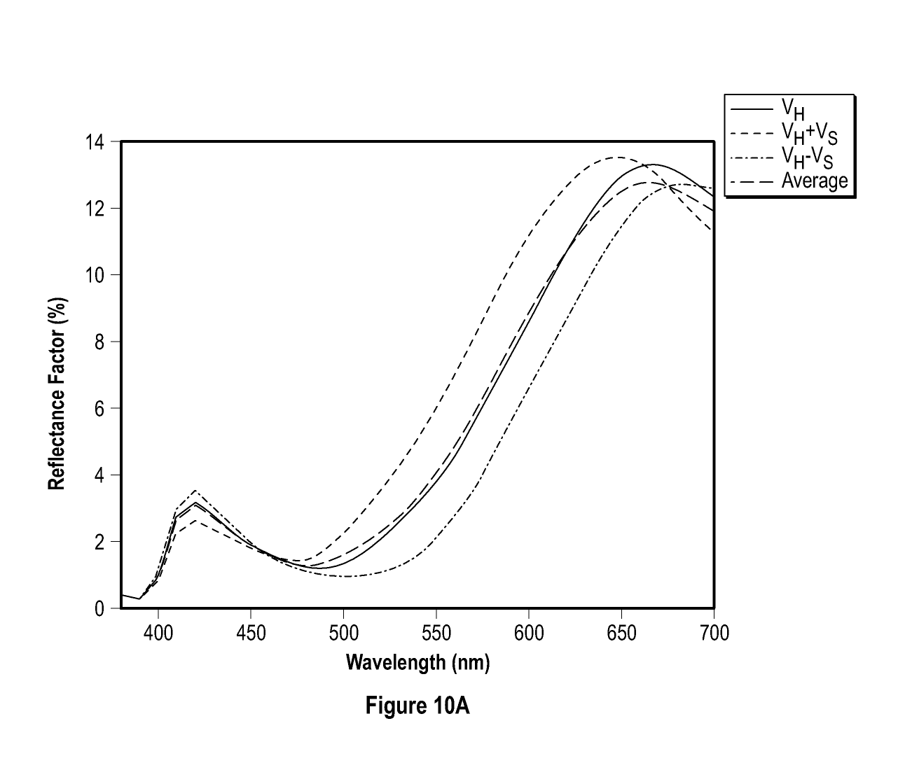

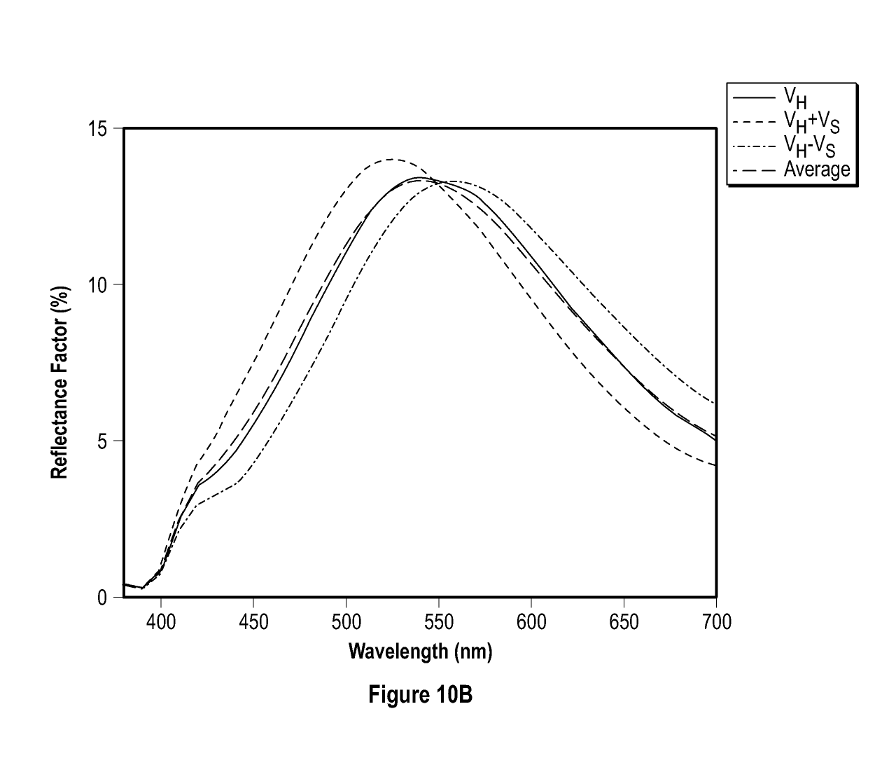

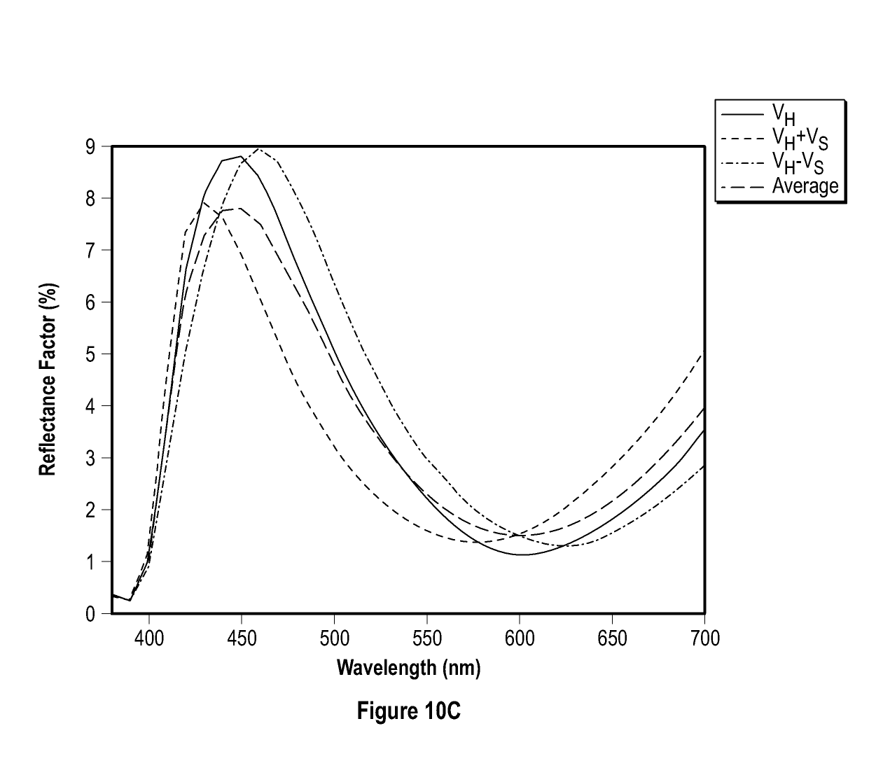

FIG. 10 shows three graphs that illustrate examples of the variation in measured reflectance for a display module displaying red display elements (a), green display elements (b), and blue display elements (c). The graphs illustrate measurements of the average reflectance factor for display panels as a function of wavelength of incident light in nanometers (x-axis) for four driving voltages V_{H}, (V_{H}+V_{S}), (V_{H}−V_{S}), and the average reflectance of the hold voltages [(Vₕ+Vₛ) and (Vₕ−Vₛ)]. These graphs illustrate examples of the wavelength (or color) shifts in reflected incident light that can occur for the voltage states (V_{H}+V_{S}) and (V_{H}−V_{S}).

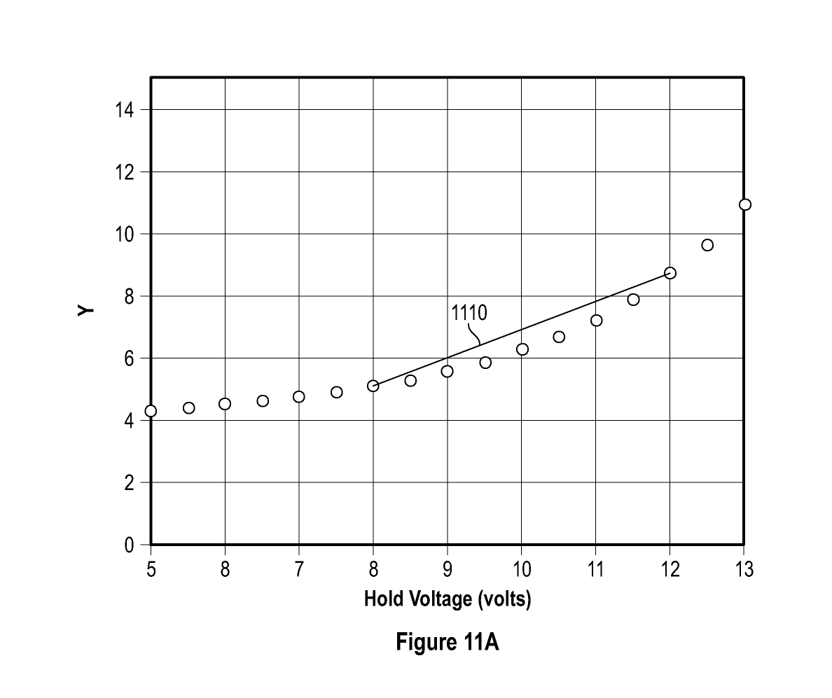

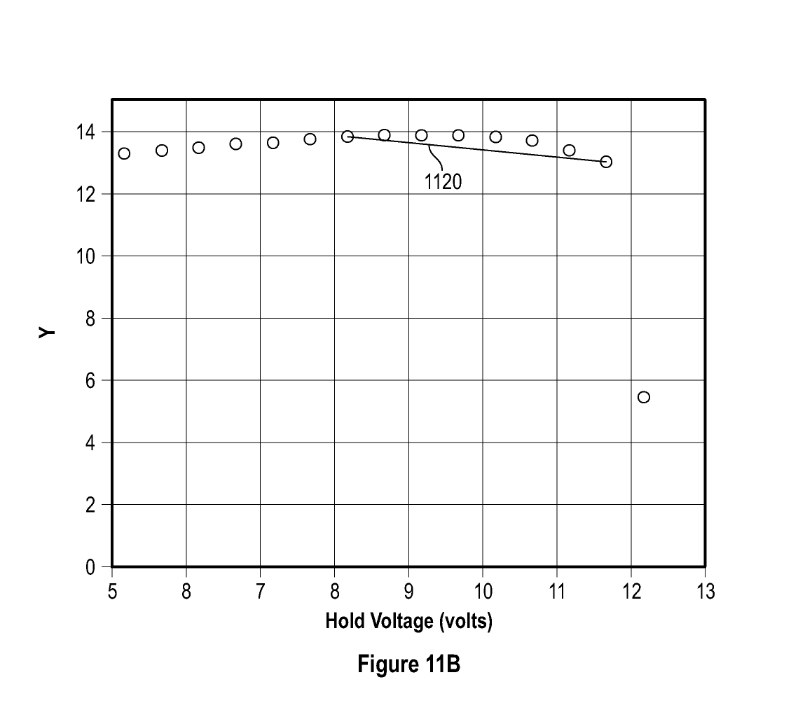

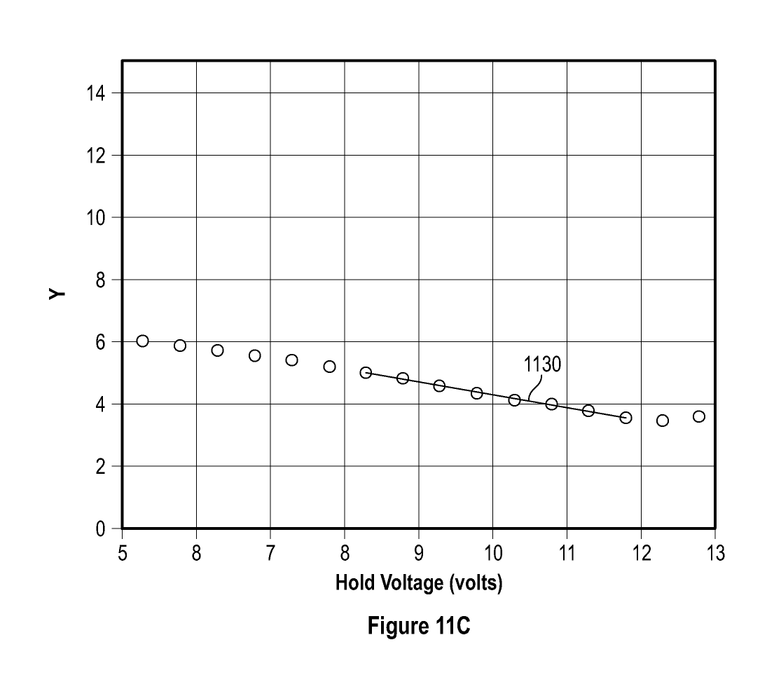

FIG. 11 shows three graphs that illustrate examples of display device luminance as a function of hold voltage for a display panel with red display devices (a), green display devices (b), and blue display devices (c). In the context of the visibility of polarity patterns, the eye may be very sensitive to the luminance component of the color differences between the voltage states. For the illustrated values of V_{H} (˜10 V) and Vs (˜2V) for red display devices, there is a difference of greater than 30 percent in the luminance of the two voltage states (V_{H}−V_{S} and V_{H}+V_{S}, corresponding to a hold voltage of eight (8) and twelve (12) volts respectively).

A line can be formed by graphing the luminance at each hold voltage level. Such lines are illustrated as lines 1110, 1120 and 1130. As illustrated in FIG. 11, the slope of the line 1120 and 1130 formed by the luminance of green and blue display elements in graph (b) and (c) are smaller than the slope of line 1110 formed by the luminance of red display elements in graph (a). This difference in slope illustrates that variations in hold voltages may produce smaller changes in luminance with green and blue display elements than with red display elements.

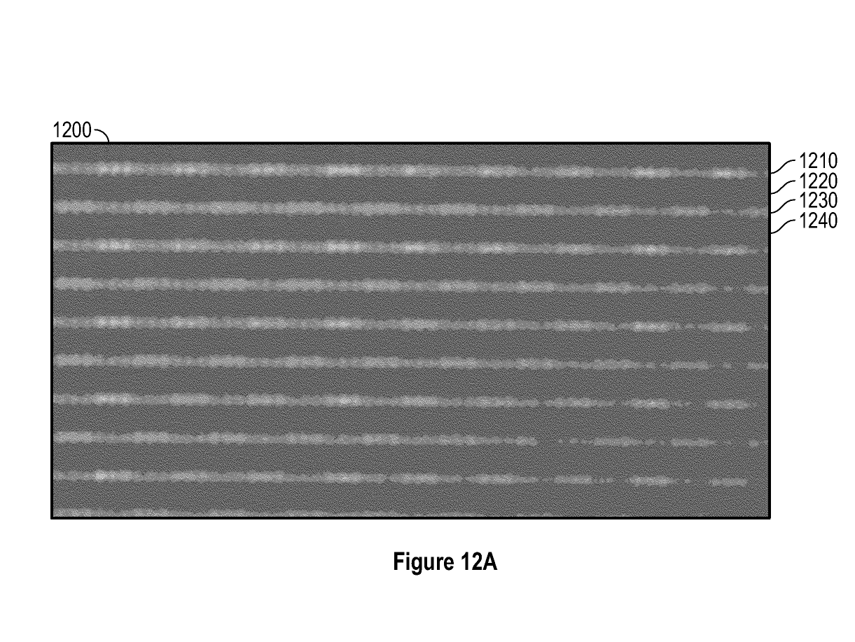

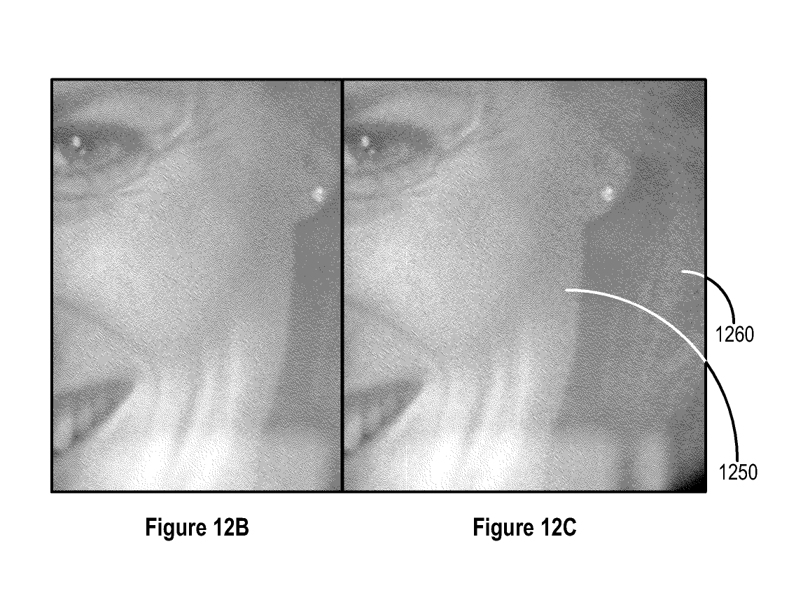

FIG. 12A is an image 1200 illustrating the severity of color differences in a red channel. FIG. 12A shows a simulated image portion 1200, with all display elements of a display panel displaying a “red” color. Display elements of the display panel are configured with hold voltages comprising a checkerboard pattern, similar to the checkerboard polarity pattern of FIG. 9. Images with areas of consistent color may provide opportunities to observe image aberrations caused by variations in hold voltages. As discussed previously, an implementation utilizing at least two voltage states to reduce charge build up in display devices may express variations in color based on the voltage states. This effect can be seen in FIG. 12A. For example, FIG. 12A illustrates rows of display elements that appear lighter, such as rows 1210 and 1230. FIG. 12 also illustrates rows of display elements that appear darker, such as rows 1220 and 1240.

In addition to the color difference that may become visible in image areas of continuous color, other image quality implications of polarity patterns may arise. For example, polarity patterns may interact with a displayed image's halftone pattern to produce image artifacts. These artifacts are illustrated in FIGS. 12B and 12C.

FIG. 12B shows an image that does not include a checkerboard voltage polarity pattern but is half toned using Floyd Steinberg error diffusion. FIG. 12C shows the same image as FIG. 12B but it also includes a checkerboard polarity pattern while the display is being held in a stable state. In FIG. 12C, the hold voltages of the display devices may be within the hysteresis window as described previously. The image of FIG. 12C shows patterns 1250 and 1260 caused by interference between the image halftoning pattern resulting from Floyd Steinberg error diffusion and the image patterns produced by hold voltages that use a checkerboard polarity pattern.

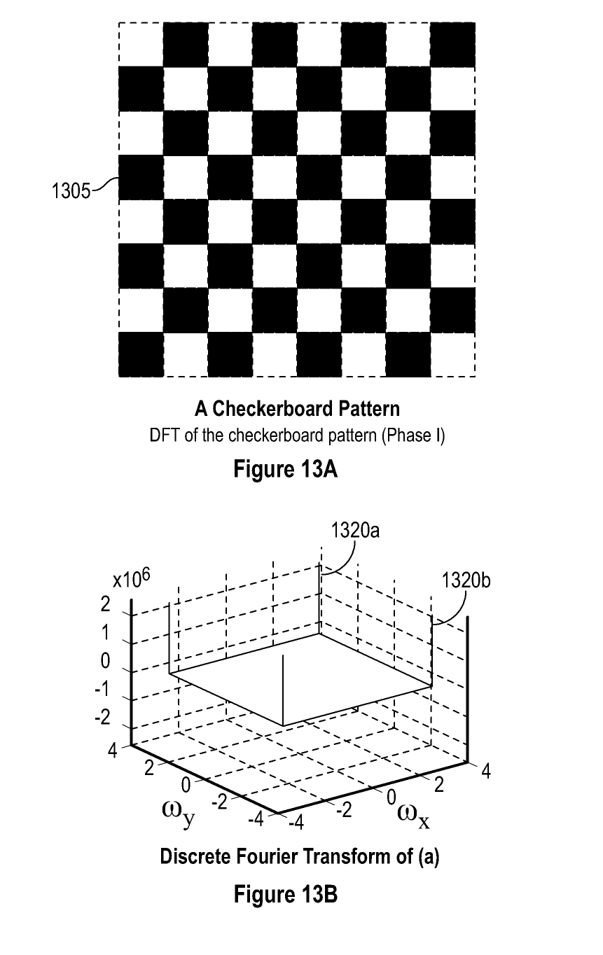

FIG. 13A shows a checkerboard pattern and FIG. 13B shows the discrete Fourier transform (DFT) of the checkerboard pattern. The DFT of the checkerboard pattern shows very strong spikes at the locations [ωₓ, ω_{y}]=[±π, ±π]. When hold voltages of display devices are configured in a checkerboard pattern, the colors of the halftone images may be modulated based on the checkerboard pattern. The modulation caused by the hold voltages may then interact with the half tone patterns of the image, introduced when the image is half-toned, for example with Floyd Steinberg error diffusion. If an image halftoning process does not consider the interaction between the half tone patterns it generates and the high frequency components of an image using hold voltages configured in a checkerboard pattern, the interaction may adversely affect image quality.

For example, a degradation in image quality may be noticeable when a static image is being displayed. When static images are displayed, the display elements may be held at a stable state within the hysteresis window, as described above with respect to FIG. 3. To prevent a charge build up while the display elements are held at a stable state, a checkerboard polarity pattern of hold voltages may be used to display the image. The visual patterns caused by the checkerboard pattern may interfere with patterns introduced by halftoning to create Moiré artifacts. Moiré artifacts are visual artifacts created in digital images by the interaction of two or more characteristics of the image.

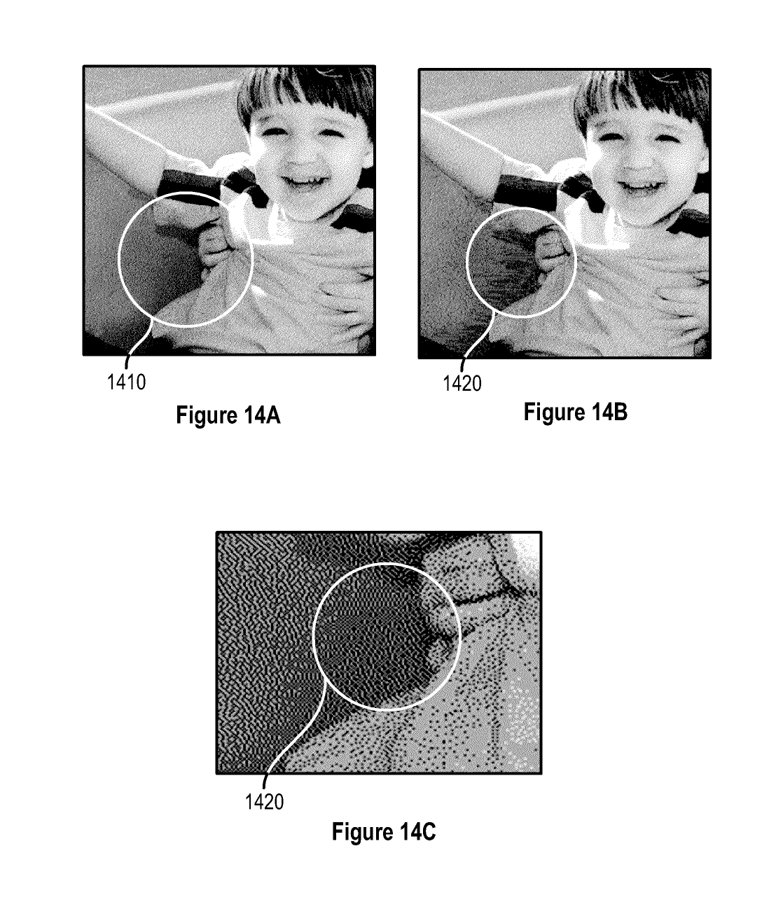

FIG. 14A shows an example image without a checkerboard pattern that was halftoned using Floyd Steinberg error diffusion. FIG. 14B shows an image using simulated hold voltages configured in a checkerboard polarity pattern. The image of FIG. 14B was also halftoned using Floyd Steinberg error diffusion. FIG. 14C shows a close-up view of an area of FIG. 14B. In the simulation that produced FIG. 14B, a plus or minus 20 percent difference in the red channel was applied to the image of FIG. 14A to simulate the effects of a checkerboard pattern of hold voltages. As a result, the checkerboard pattern of FIG. 14B can be seen interfering with the image's halftone pattern. This results in a noisy appearance, especially in the area surrounded by the circle 1420, when compared to area surrounded by circle 1410 of FIG. 14A, which is not using a simulated checkerboard pattern of hold voltages. The noisy appearance is a spatial artifact, also known as a Moiré artifact. These artifacts may be observable in images including a halftone pattern with a frequency close to the frequency of the checkerboard pattern of hold voltages.

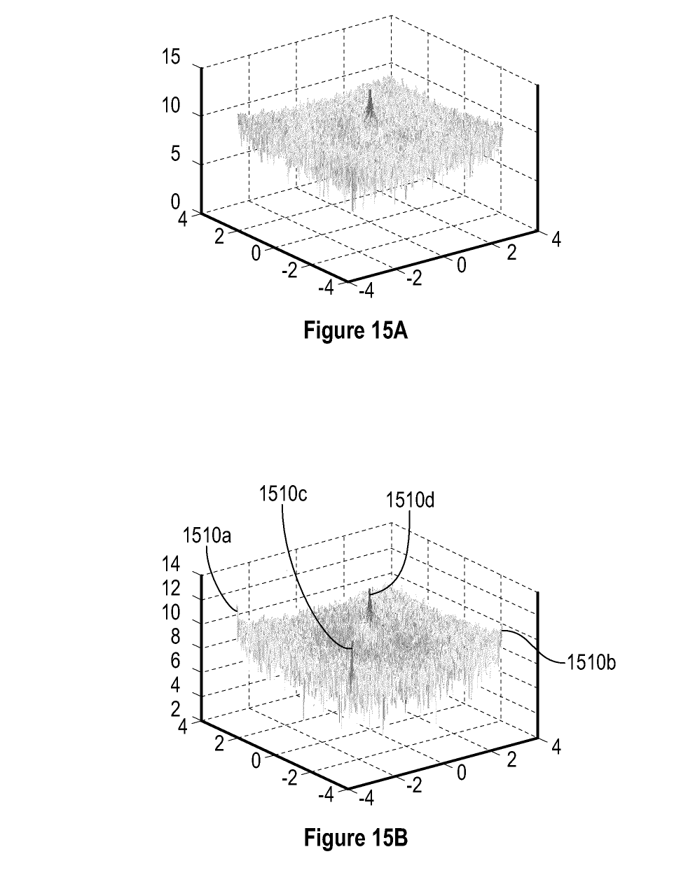

FIG. 15A illustrates the discrete Fourier transform (DFT) of the image shown in FIG. 14A. FIG. 15B illustrates the discrete Fourier transform (DFT) of the image shown in FIG. 14B. FIG. 15B illustrates high frequency components of the checkerboard pattern near diagonal locations at [±π, ±π]. These high frequency components may be seen at points 1510a-c of FIG. 15. A spike also appears at the origin point, corresponding to the DC component, or image mean, of the image.

One method to reduce visual artifacts caused by voltage polarity patterns is to reduce interaction between image patterns introduced by the half toning process and image patterns introduced by the hold voltage pattern. For example, one method generates a halftone image such that the frequencies introduced into the image by the half-toning process do not interact with the visual patterns introduced by the hold voltage pattern. When hold voltage polarities are provided in a pattern across an image such as the checkerboard described above, image halftone patterns with frequencies near diagonal frequencies may produce visual artifacts. Shifting these near diagonal frequency components of the half tone patterns to diagonal frequencies may reduce visual artifacts in the image while maintaining visual quality. These halftone patterns may be produced by modulation of a threshold used in error diffusion.

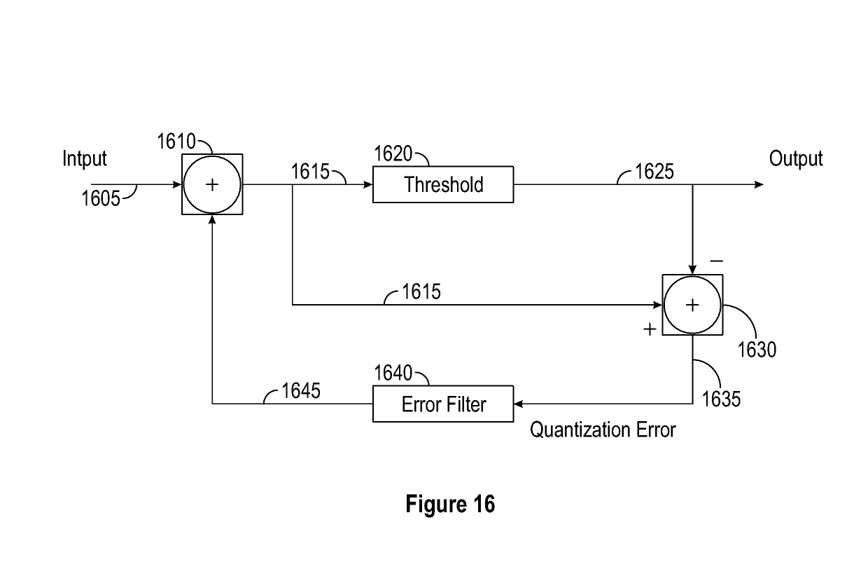

FIG. 16 shows an example data flow diagram for diffusing quantization error of an input pixel with Floyd Steinberg error diffusion. Some error diffusion methods may raster scan through an image. A continuous-tone pixel value may be compared with a threshold (or a series of thresholds in case of multilevel halftoning); the pixel may be assigned an output value corresponding to the tone level associated with the nearest threshold value. Quantization error may be computed by subtracting the output value from the input value. The quantization error may then be distributed to pixel locations that are yet to be processed. With this method, overall quantization errors may be compensated. This may improve the visual perception of a continuous-tone color image when using a limited number of color levels. One implementation of this method was introduced by Floyd and Steinberg and is appropriately named Floyd Steinberg error diffusion.

The data flow of FIG. 16 begins when input pixel 1605 is provided to adder 1610. Adder 1610 adds remaining error from previous quantization's to input pixel 1605. The adjusted pixel value 1615 is then quantized via threshold 1620. To quantize the adjusted pixel value 1615 via a threshold, the adjusted pixel value, which is a continuous-tone pixel value, is compared with a threshold, or a series of thresholds in case of multilevel halftoning. The quantized value 1625 is then assigned a value corresponding to the tone level associated with the nearest threshold value. In some aspects, the quantized value 1625 is then written to a display element or a group of display elements as an output pixel. The difference between the adjusted pixel value 1615 and the result of the quantization 1625 is the quantization error. This is determined by adder 1630. The error calculated by adder 1630 is error 1635. Error 1635 is then sent to the error filter 1640. After the error is filtered, a filtered error value 1645 is provided as input to adder 1610. Adder 1610 then adjusts the next input pixel based at least in part, on filtered error value 1645.

To shift near diagonal frequencies of halftone patterns to the diagonal frequencies, such as the frequencies shown at ±π in FIG. 13, the threshold used by the error diffusion method may be modulated. In standard Floyd Steinberg error diffusion for example, a fixed threshold T may be used to quantize a pixel. If quantizing input pixels that vary between zero (black) and one (full color), a threshold of 0.5 may be used. T may also represent a median threshold.

In the model based error diffusion methods described here, the threshold, which may be fixed in traditional error diffusion methods, may be modulated. For example, in some implementations, the modulation may alter the interaction between the visual patterns created by hold voltages of display devices that use a checkerboard pattern, and the patterns introduced to the image by the image halftoning method. In some implementations, the threshold (T) may be modulated between, for example, T−∈ and T+∈. More details of ∈ and modulation of the threshold are discussed below.

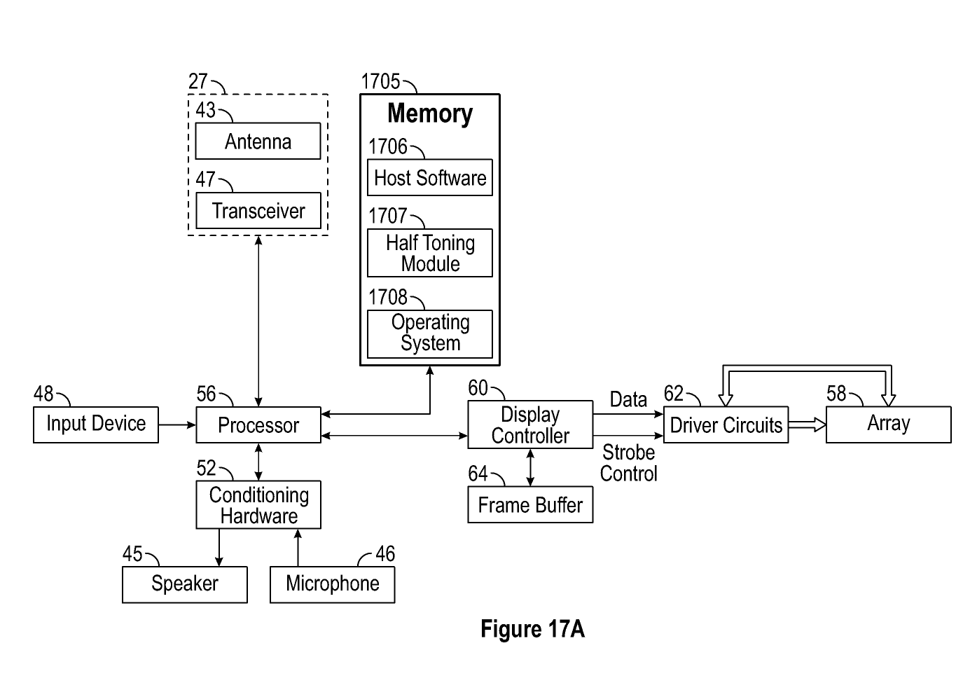

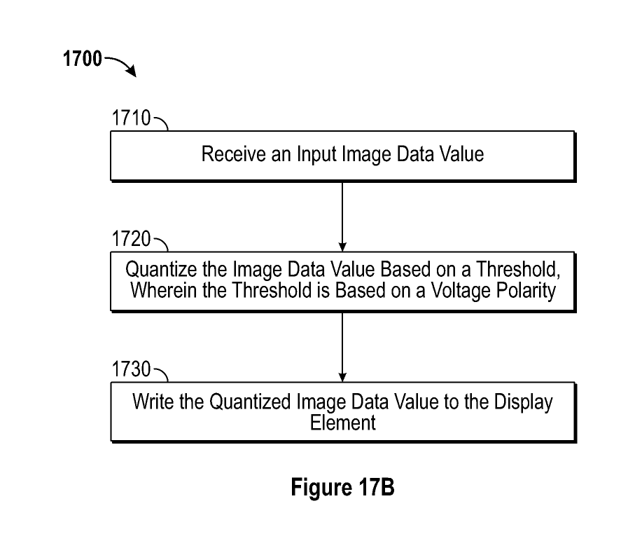

FIG. 17A is an example system block diagram illustrating a visual display device 40 including a plurality of interferometric modulators. The display device 40 can be, for example, a cellular or mobile telephone. However, the same components or slight variations thereof are also illustrative of various other types of display devices such as televisions, laptop or notebook computers, and portable media players.

The display device 40 may include a housing, a display array 58, an antenna 43, a speaker 45, an input device 48, and a microphone 46. The housing may generally formed from any of a variety of manufacturing processes, including injection molding, and vacuum forming. In addition, the housing may be made from any of a variety of materials, including but not limited to plastic, metal, glass, rubber, and ceramic, or a combination thereof. In one implementation the housing includes removable portions that may be interchanged with other removable portions of different color, or containing different logos, pictures, or symbols.

The display array 58 of display device 40 may be any of a variety of displays including a bi-stable display, or interferometric modulator display as described herein. In other implementations, the display 58 includes a flat-panel display, such as plasma, EL, OLED, STN LCD or TFT LCD as described above, or a non-flat-panel display, such as a CRT or other tube device.

The illustrated display device 40 can include additional components associated therewith. For example, in one implementation, the display device 40 includes a network interface 27 that includes an antenna 43 which is coupled to a transceiver 47. The transceiver 47 is connected to a processor 56, which is connected to conditioning hardware 52. The conditioning hardware 52 may be configured to condition a signal (e.g. filter a signal). Conditioning hardware 52 generally includes amplifiers and filters for transmitting signals to the speaker 45, and for receiving signals from the microphone 46. Conditioning hardware 52 may be discrete components within the display device 40, or may be incorporated within the processor 56 or other components.

The conditioning hardware 52 is connected to a speaker 45 and a microphone 46. The processor 56 is also connected to an input device 48 and a driver controller 29. A power supply (not shown) provides power to all components as required by the particular display device 40 design. The power supply can include a variety of energy storage devices as are well known in the art. For example, in one implementation, the power supply is a rechargeable battery, such as a nickel-cadmium battery or a lithium ion battery. In another implementation, the power supply is a renewable energy source, a capacitor, or a solar cell, including a plastic solar cell, and solar-cell paint. In another implementation, the power supply is configured to receive power from a wall outlet.

The network interface 27 includes the antenna 43 and the transceiver 47 so that the display device 40 can communicate with one or more devices over a network. In one implementation the network interface 27 may also have some processing capabilities to relieve requirements of the processor 56. The antenna 43 is any antenna for transmitting and receiving signals. In one implementation, the antenna transmits and receives RF signals according to the IEEE 802.11 standard, including IEEE 802.11(a), (b) or (g). In another implementation, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 56. The transceiver 47 also processes signals received from the processor 56 so that they may be transmitted from the display device 40 via the antenna 43.

In an alternative implementation, the transceiver 47 can be replaced by a receiver. In yet another alternative implementation, network interface 27 can be replaced by an image source, which can store or generate image data to be sent to the processor 56. For example, the image source can be a digital video disc (DVD) or a hard-disc drive that contains image data, or a software module that generates image data.

The input device 48 allows a user to control the operation of the display device 40. In one implementation, input device 48 includes a keypad, such as a QWERTY keyboard or a telephone keypad, a button, a switch, a touch-sensitive screen, a pressure- or heat-sensitive membrane. In one implementation, the microphone 46 is an input device for the display device 40. When the microphone 46 is used to input data to the device, voice commands may be provided by a user for controlling operations of the display device 40.

The device may include a memory 1705. The memory includes software modules that include instructions for processor 56. For example, memory 1705 is illustrated as including host software 1706, a half-toning module 1707, and an operating system module 1708. These instructions configure processor 56 to perform the functions of device 40.

Operating system module 1708 may include instructions that configure processor 56 to manage the hardware and software resources of device 40. Host software module 1706 and half toning module 1707 may include instructions for one or more application programs that are running on the one or more processors 56 in the device. For example, instructions in one or more host software programs may configure processor 56 to control what is to be displayed on the array 58. The processor 56 will generally include an internal memory (not shown) for storing image data, and includes electronic processing circuitry configured to process this image data as defined by one or more software or firmware programs running on the processor 56.

Although instructions in host software determine what information is displayed on array 58, direct control over the pixels of the array is generally allocated to a display controller 60 and driver circuits 62. Although illustrated as two blocks in FIG. 17A, these two functions are often part of one controller integrated circuit, as is shown, for example, in FIG. 2. As described above, the driver circuits 62 generates and applies the segment and common waveforms of, for example, FIG. 5A, in accordance with the display data and line strobe timing required to place the pixels of the array in the state desired by the host software.

As the host receives and/or generates pixel data for display, it stores that data in a frame buffer 64. The host may have direct access to these memory locations, or it may access them through the display controller 60. The frame buffer 64 may be incorporated into the display controller 60. The display controller 60 reads the memory locations that constitute the frame buffer, and places the data into the correct format and timing to operate the driver circuits 62.

Processor instructions included in the host software module 1706 or half toning module 1707 illustrated in FIG. 17A may also perform half toning operations on image data to be displayed on array 58. For example, in some implementations, the half toning module may dither image data with a mask or perform error diffusion on image data before it is displayed on array 58. In some implementations, Floyd Steinberg error diffusion may be implemented by instructions included in the half toning module running on processor 56. In other implementations, the disclosed model based error diffusion may be implemented by instructions included in one or more host programs or the half toning module 1707. These instructions may configure processor 56 to perform the described model based error diffusion on image data, which is then displayed on array 58. For example, instructions in half toning module 1707 may configure process 56 to receive an image data value. Additional instructions in half toning module 1707 may then quantize the image data value based on a threshold. The threshold may be based on a voltage applied to a display element of the array 58. Instructions in the half toning module 1707 may then write the quantized image data value to the display element in the array 58.

FIG. 17B is a flowchart illustrating one example of a method 1700 for reducing artifacts caused by polarity patterns in an image rendered on an electronic display. In some aspects, process 1700 may be implemented in the operating system or software modules executing on processor 21, illustrated in FIG. 2. In some implementations, process 1700 may be implemented by instructions included in one or more host software programs or half toning modules running on processor 56, as illustrated in FIG. 17A. Process 1700 begins at processing block 1710 where an input image data value is received. In processing block 1720, the image data value is quantized based on a threshold, with the threshold based on a voltage polarity. The threshold may be varied, in some implementation by a value ∈. For example, the threshold for some voltage polarities may be a threshold T+∈. The threshold for other voltage polarities may be a threshold T−∈.

The value of ∈ can vary based on the luminance difference caused by the alternating voltage polarity patterns of the checkerboard. In some implementations, an value equal to 10 percent of the quantization interval may achieve good results when the voltage polarity pattern causes a plus or minus twenty percent luminance difference between display elements. For instance, if quantizing input pixels that vary between zero (black) and one (full color) in bi-level halftoning, then the quantization interval will be 1, and thus ∈ will be 0.1.

In processing block 1730, the quantized image data value is written to a display element of the electronic display.

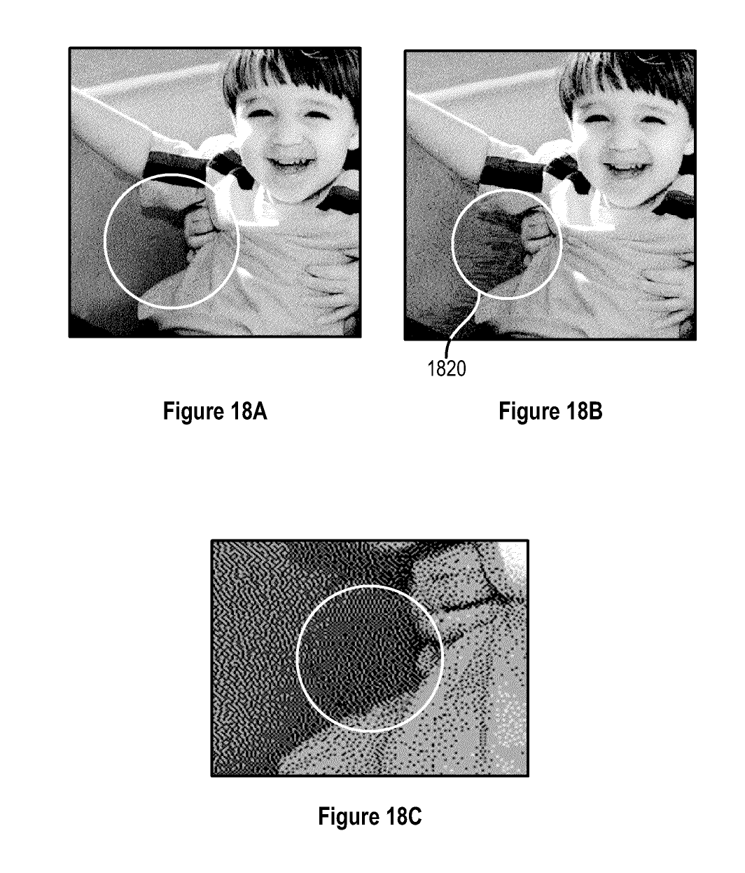

FIG. 18A illustrates an example of an image generated using model based error diffusion with threshold modulation. The image of FIG. 18A was produced by display devices that do not use hold voltages configured in a checkerboard polarity pattern. FIG. 18B illustrates an example of an image generated using a model based error diffusion method that also includes a simulation of display devices using hold voltages configured in a checkerboard polarity pattern. FIG. 18C shows a close-up view of an area of FIG. 18B. The simulation of the voltage polarity pattern uses a plus or minus 20 percent luminance difference in the red channel. Artifacts may be reduced in the image with the new modulated threshold halftoning approach discussed above. For example, region 1820 of FIG. 18B, which includes the simulated checkerboard voltage polarity pattern and is produced with the new modulated threshold (model based) halftoning approach, may appear less noisy and more uniform when compared to the corresponding region 1420 of FIG. 14B, prepared using traditional halftoning methods. This can be further observed in the close-up view shown in FIG. 18C, as compared to FIG. 14C.

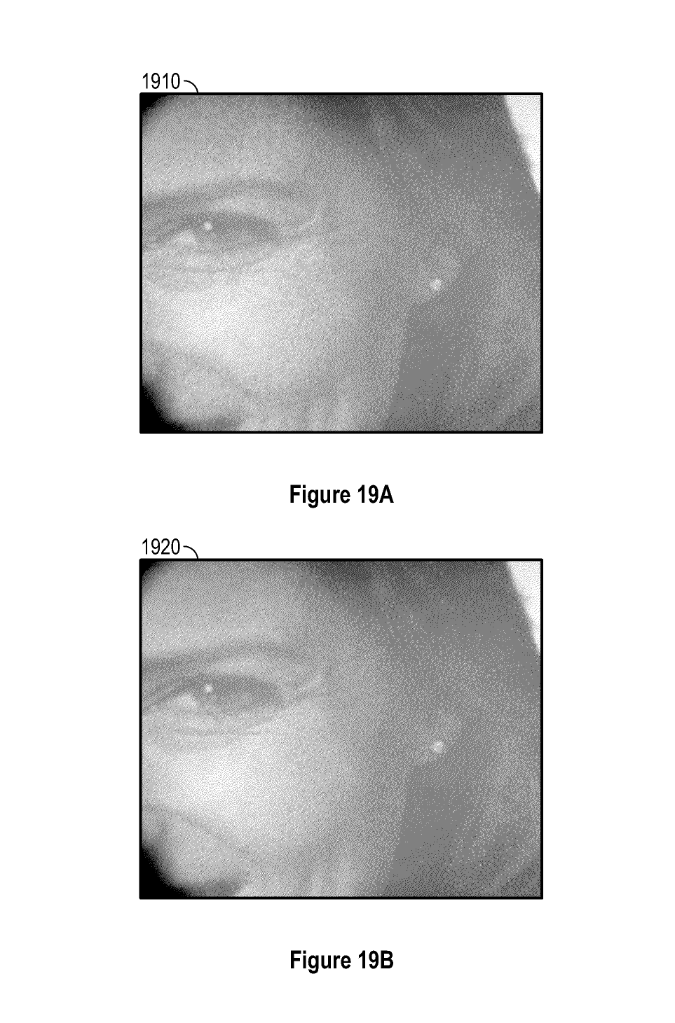

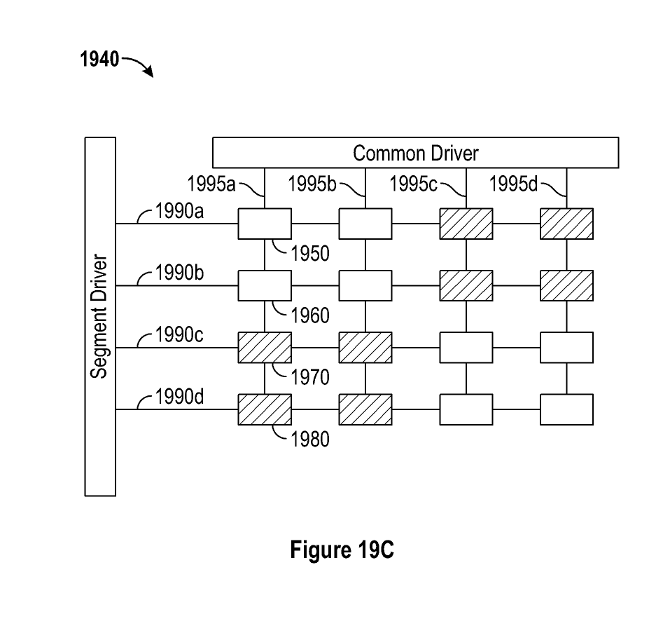

FIGS. 19A and 19B illustrate examples of images displayed on an IMOD module. FIG. 19A shows an image 1910 generated by original error diffusion while FIG. 19B shows an image 1020 generated by the disclosed model based error diffusion method.

To generalize the halftoning method described above to operate with more complex patterns of frequency characteristics, an array of modulation values may be used. For example, a 4×4, 8×8, or other sized array may be employed depending on the frequency characteristics of the voltage polarity pattern. One example of a 4×4 modulation array is shown below in Table 1. In this example, each element in the modulation array indicates the ∈ value for the threshold modulation.

TABLE 1

| | 1 | 2 | 3 | 4 |
|---|---|---|---|---|
| 1 | 0.1 | 0.1 | −0.1 | −0.1 |
| 2 | 0.1 | 0.1 | −0.1 | −0.1 |
| 3 | −0.1 | −0.1 | 0.1 | 0.1 |
| 4 | −0.1 | −0.1 | 0.1 | 0.1 |

FIG. 19C illustrates an example voltage polarity pattern for a portion of a display. In FIG. 19C, the shading of a display element denotes a hold voltage of a particular polarity for that display element. For example, display elements 1950 and 1960 may have the same hold voltage polarity. Display elements 1970 and 1980 may also have the same hold voltage polarity, which is different that the voltage polarity for display elements 1950 and 1960.

The polarity pattern is distributed across a four by four matrix of segment lines 1990a-d and common lines 1995a-d. The modulation array in Table 1 above may be used to perform some of the halftoning methods discussed above when the polarity pattern shown in FIG. 19C is applied to hold voltages for display devices of the display.

To apply the thresholds defined by Table 1, a half toning method may first identify a correspondence between the current display element's hold voltage and the voltage polarity pattern. For example, the halftoning method may determine that the current display element corresponds to position 1950 or position 1960 of the voltage polarity pattern. Based on the current display element's position in the voltage polarity pattern, the half toning method may then index into table 1 to determine the threshold to apply to the current display element.

For example, if the current display element corresponds to the position 1950 in the voltage polarity pattern, the method may then determine that position 1950 corresponds to row 1, column 1 of the voltage polarity pattern. The method may then retrieve the element at row 1, column 1 from table 1 to obtain a threshold to use when performing error diffusion on the current display element. Similarly, if the current display element's position in the voltage polarity pattern corresponds to position 1980 in FIG. 19C, the method may determine that position 1980 corresponds to row 4, column 1 of the voltage polarity pattern. The method may then retrieve the element from row 4, column 1 of table 1 to determine the threshold to use with the current display element.

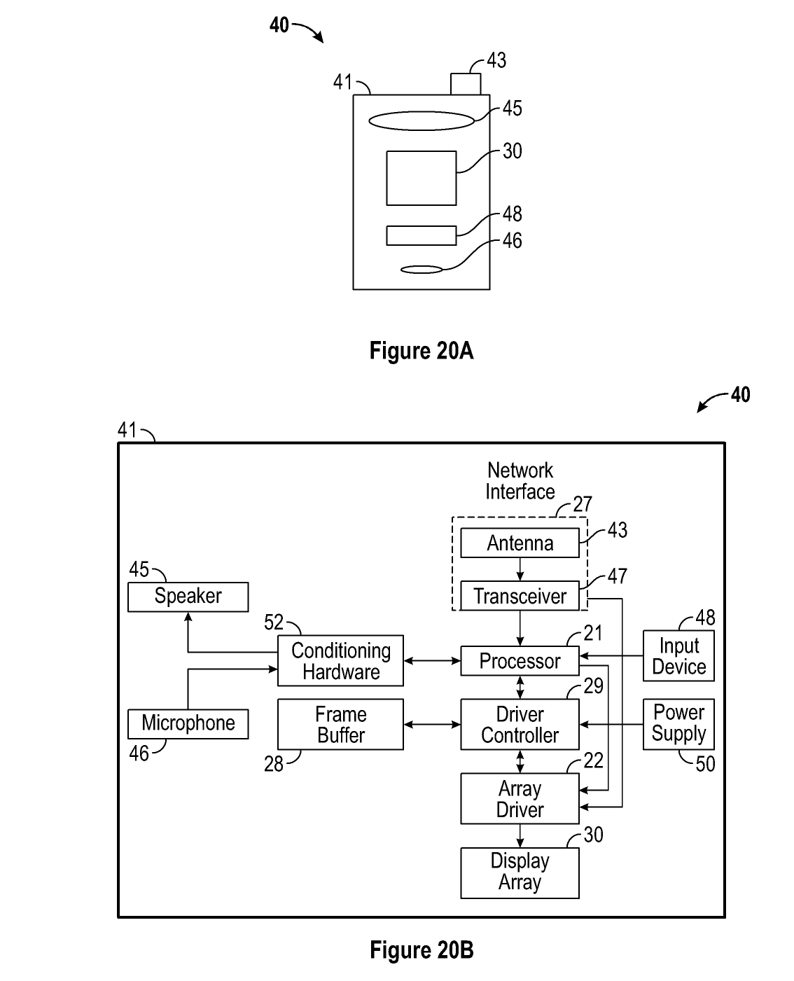

FIGS. 20A and 20B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 19B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method to display an image in an electronic display, the method comprising:
receiving an input image data value of the image;
quantizing the input image data value based on a threshold, wherein the threshold is modulated based, at least in part, on a voltage of a display element drive signal applied onto a display element of the electronic display; and
writing the quantized image data value to the display element.

2. The method of claim 1, wherein the electronic display includes a plurality of common lines and a plurality of segment lines connected to an array of display elements, and wherein the voltage of the display element drive signal is the voltage between a common line and a segment line that are configured to drive the display element, and wherein at least two display element drive signals with different voltages drive different display elements in the display to render the same data value.

3. The method of claim 1, further comprising error diffusing a quantization error resulting from quantizing the image data value based on the threshold.

4. The method of claim 1, wherein the threshold is below a median threshold value if the voltage drive signal darkens the display element relative to a median hold voltage.

5. The method of claim 1, wherein the threshold is above a median threshold value if the modulated voltage drive signal lightens the display element relative to a median hold voltage.

6. The method of claim 1, further comprising iteratively repeating the receiving, quantizing, and writing for a plurality of display elements within the electronic display.

7. An apparatus for driving a display, the apparatus comprising:
a segment driver configured to drive a plurality of segment lines of the display;
a common driver configured to drive a plurality of common lines of the display, the plurality of the segment lines and the plurality of common lines connected to an array of display elements in the display,
wherein the common driver is configured to alternate voltage states applied to the plurality of common lines in a first pattern having a first frequency spectrum, and
wherein the segment driver is configured to alternate voltage states applied to the plurality of segment lines in a second pattern having a second frequency spectrum; and
a halftoning module, configured to modulate a quantization threshold for the array of display elements based at least in part on the first frequency spectrum and the second frequency spectrum.

8. The apparatus of claim 7, wherein the halftoning module is further configured to diffuse a quantization error resulting from quantizing an image data value based on the quantization threshold.

9. An apparatus to display an image, comprising:
an electronic display including an array of display elements, a plurality of common lines, and a plurality of segment lines, the plurality of common lines and the plurality of segment lines connected to the array of display elements;
a segment driver configured to drive the plurality of segment lines;
a common driver configured to drive the plurality of common lines, wherein the segment driver and the common driver operate together to write data to the array of display elements; and
a halftoning module, configured to
receive an input data value of the image,
quantize the image data value based on a threshold, wherein the threshold is based on a voltage applied onto a display element of the array of display elements in the electronic display, and
write the quantized image data value to the display element.

10. The apparatus of claim 9, wherein the voltage difference is based on the voltage between a common line and a segment line that are configured to drive the display element.

11. The apparatus of claim 9, further comprising:
a processor that is configured to communicate with the electronic display, the processor being configured to process image data; and
a memory device that is configured to communicate with the processor.

12. The apparatus of claim 9, further comprising:
a driver circuit configured to send at least one signal to the electronic display.

13. The apparatus of claim 12, further comprising:
a controller configured to send at least a portion of the image data to the driver circuit.

14. The apparatus of claim 11, further comprising:
an image source module configured to send the image data to the processor.

15. The apparatus of claim 14, wherein the image source module includes at least one of a receiver, transceiver, and transmitter.

16. The apparatus of claim 11, further comprising:
an input device configured to receive input data and to communicate the input data to the processor.

17. An apparatus for driving an electronic display including a plurality of common lines and a plurality of segment lines connected to an array of display elements, the apparatus comprising:
means for driving the plurality of segment lines;
means for driving the plurality of common lines, wherein at least two display elements in the array that are driven to render the same data are provided a different driving voltage; and
means for halftoning, configured to
receive an input image data value of an image,
quantize the image data value based on a threshold, wherein the threshold is modulated based on the voltage applied onto a display element of the array of display elements, and
write the quantized image data value to the display element.

18. The apparatus of claim 17, wherein the means for driving the plurality of segment lines includes a column driver configured to drive the plurality of segment lines.

19. The apparatus of claim 17, wherein the means for driving the plurality of common lines includes a row driver configured to drive the plurality of common lines;

20. The apparatus of claim 17, wherein the means for halftoning includes a processor configured to communicate with an array driver, the array driver including a row driver circuit and a column driver circuit, and wherein the processor is further configured to execute one or more software modules.

21. A non-transitory, computer readable storage medium having instructions stored thereon that cause a processing circuit to perform a method comprising:
receiving an input image data value of an image;
quantizing the image data value based on a threshold, wherein the threshold is modulated based on a voltage drive signal provided onto a display element in the electronic display; and
writing the quantized image data value to the display element.

22. The computer readable storage medium of claim 21, wherein the voltage drive signal is a voltage between a common line and a segment line that are configured to drive the display element.

23. The computer readable storage medium of claim 21, wherein the method further includes diffusing a quantization error resulting from quantizing the image data value based on the threshold.

24. The computer readable storage medium of claim 21, wherein the threshold is below a median threshold value if the voltage drive signal darkens the display element relative to a median hold voltage.

25. The computer readable storage medium of claim 21, wherein the threshold is above a median threshold value if the voltage drive signal lightens the display element relative to a median hold voltage.
